(19) United States
(12) Patent Application Publication
(10) Pub. No.: US 2008/0171261 A1
(43) Pub. Date: Jul. 17, 2008

(54) Conductive component

(75) Inventor: Chien-Tung Wang, Chung-Ho City (TW)

Correspondence Address: Joe McKinney Muncy, PO Box 1364, Fairfax, VA, 22038-1364, US

(73) Assignee: Kendoo Technology Co., Ltd.

(21) Appl. No.: 12/007,457

(22) Filed: Jan. 10, 2008

(30) Foreign Application Priority Data
Jan. 16, 2007 (TW) 096200805

(51) Int. Cl. H01M 2/10; H01B 5/00

(52) U.S. Cl. 429/100; 174/126.1

(57) ABSTRACT

A conductive component has a housing and a conductor. The housing is conductive and has a contact end, a distal end, a through hole and an inner surface. The through hole is formed through the contact end and the distal end. The conductor is mounted movably in the through hole of the housing and has a distal end, a proximal end, a conducting portion and a side wall. The proximal end of the conductor is held in the through hole of the housing. The conducting portion is formed on and protrudes out from the proximal end of the conductor and protrudes out from the contact end of the housing. The side wall corresponds to and abuts the inner surface of the housing. Because the conductor has an increased surface to contact with the inner surface of the housing, the battery holder has an improved current tolerance.

### BACKGROUND OF THE INVENTION

1. Field of the Invention

The present invention relates to a conductive component, and more particularly to a conductive component with an improved current tolerance.

2. Description of the Prior Arts

With raising public awareness of environmental protection, usage of electric vehicles gradually increases. An electric vehicle usually requires a battery having electrodes to store electricity. Conventionally, the battery is mounted securely in the electric vehicle and the electrodes of the battery are connected securely. Therefore, the battery cannot be easily removed from the electric vehicle, causing difficulty in maintaining the electric vehicle. Thus a conventional battery holder has been designed for accommodating a battery and transmitting electricity from the battery to the electric vehicle.

With reference to FIG. 6, the conventional battery holder comprises a body, an opening being formed on the body and multiple conventional conductive components (30).

The body is hollow and has a front, a rear, multiple setting holes and an opening. The setting holes are formed on the front of the body. The opening is formed on the rear of the body and allows a battery to be inserted into the body.

The conventional conductive components (30) are mounted respectively in the setting holes and each conventional conductive component (30) has a housing (31), a conductor (32), a spring (33) and a base.

The housing (31) is made of a conductive material, is mounted in the setting hole of the body and has a contact end, a distal end, an outer surface, a through hole and an inner surface. The contact end of the housing (31) is mounted through the setting hole of the body and is mounted in the body. The distal end is opposite to the contact end. The through hole is formed through the contact end and the distal end.

The conductor (32) is mounted in the through hole of the housing (31) and has a protruding end, a connecting end and a shoulder. The protruding end of the conductor (32) protrudes out from the contact end of the housing (31) to contact an electrode of a battery. The shoulder is mounted inside the housing (31), near the connecting end of the conductor (32) to prevent the conductor (32) being separated from the housing (31).

The spring (33) is mounted in the through hole of the housing (31) and presses the connecting end of the conductor (32).

The base is attached to the distal end of the housing (31) and has an inside surface and an outside surface. The inside surface abuts the spring (33).

When in use, a battery with an electrode is inserted into the body, the electrode of the battery presses against the protruding end of the conductor (32). The conductor (32) is pushed toward the connecting end of the conductor (32) to compress the spring (33). The spring (33) then pushes the conductor (32) back resulting in a stable connection. Therefore, the electrode of the battery is detachably mounted to the electric car and the battery can be removed easily for maintenance or replacement.

However, when the battery transiently produces a high current, the high current may cause the spring (33) of the conventional battery holder to melt. In consequence, the conductor (32) of the conventional conductive component (30) of the conventional battery holder fails and must be replaced.

To overcome the shortcomings, the present invention provides a conductive component to mitigate or obviate the aforementioned problems.

### SUMMARY OF THE INVENTION

The primary objective of the present invention is to provide a battery holder having a conductive component with improved current tolerance. The conductive component has a housing and a conductor. The housing is conductive and has a contact end, a distal end, a through hole and an inner surface. The through hole is formed through the contact end and the distal end. The conductor is mounted movably in the through hole of the housing and has a distal end, a proximal end, a conducting portion, a side wall and a recess. The proximal end of the conductor is held in the through hole of the housing. The conducting portion is formed on and protrudes out from the proximal end of the conductor and protrudes out from the contact end of the housing. The side wall corresponds to and abuts the inner surface of the housing. The recess is formed coaxially in the distal end of the conductor. Because the conductor has an increased surface to contact with the inner surface of the housing, the battery holder has an improved current tolerance.

Based on the structure of the battery holder as described, the conductor in accordance with the present invention has an added surface of the side wall in contact with the housing, whereby a high current transiently produced by a battery passes through the added outer surface and does not cause the spring of the battery holder in accordance with the present invention to melt. In consequence, the battery holder in accordance with the present invention has an improved transient current tolerance.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a battery holder with multiple conductive components in accordance with the present invention;

FIG. 2 is an exploded perspective view of the conductive component in FIG. 1;

FIG. 3 is a perspective view of the conductive component in FIG. 2;

FIG. 4 is a side view in partial section of the conductive component in FIG. 2;

FIG. 5 is an operational side view in partial section of the conductive component in FIG. 2; and

FIG. 6 is a side view in partial section of a conventional batter holder with multiple conventional conductive components in accordance with the prior art.

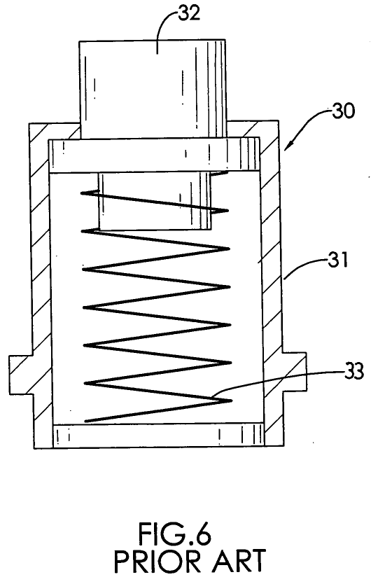

### DETAILED DESCRIPTION OF THE PREFERRED EMBODIMENTS

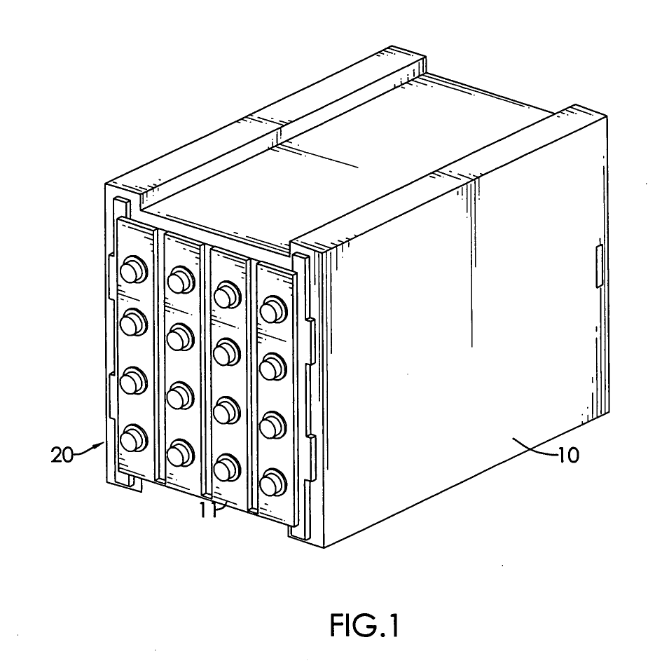

With reference to FIG. 1, a battery holder comprises a body (10) and multiple conductive components (20) in accordance with the present invention.

The body (10) is hollow and has a front, a rear, multiple setting holes, an opening and an optional panel (11). The setting holes are formed in the front of the body (10). The opening is formed in the rear of the body (10) and allows a battery to be inserted into the body (10). The panel (11) is mounted on the front of the body (10) and has multiple assembling holes. The assembling holes are formed through the panel (11) and respectively align with the setting holes.

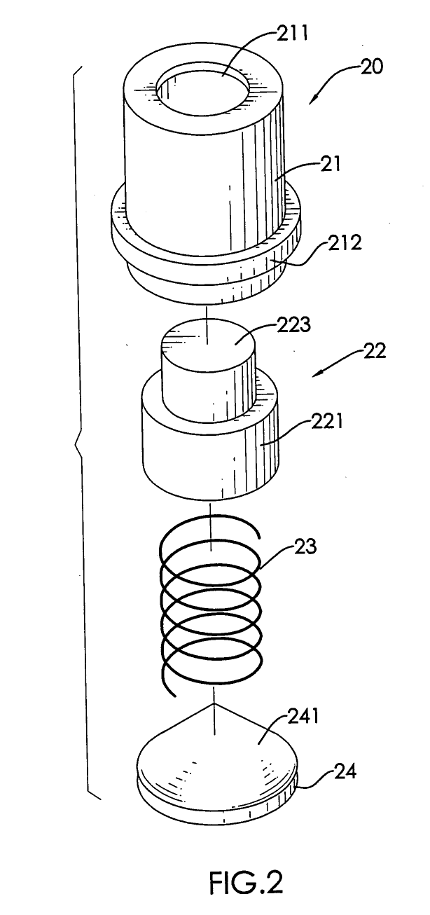

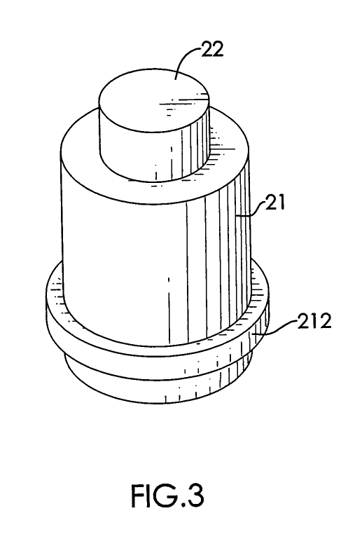

With further reference to FIGS. 2 and 3, the conductive components (20) are mounted respectively in the body (10). Each conductive component (20) has a housing (21), a conductor (22), a spring (23) and a base (24).

The housing (21) is conductive, is mounted in the corresponding setting hole of the body (10), may be mounted through the corresponding assembling hole of the panel (11) and has a contact end, a distal end, an outer surface, a through hole (211), an inner surface and an optional flange (212). The contact end of the housing (21) protrudes out of the setting hole of the body (10) and may be protrude out of the assembling hole of the panel (11). The distal end is opposite to the contact end and is mounted in the body (10). The through hole (211) is formed through the contact end and the distal end and has a contact end opening (213) with a diameter smaller than an inner diameter of the through hole (211). The flange (212) is formed on the outer surface of the housing (21) near the distal end, may be formed around the housing (21) and is securely attached to the corresponding assembling hole of the panel (11).

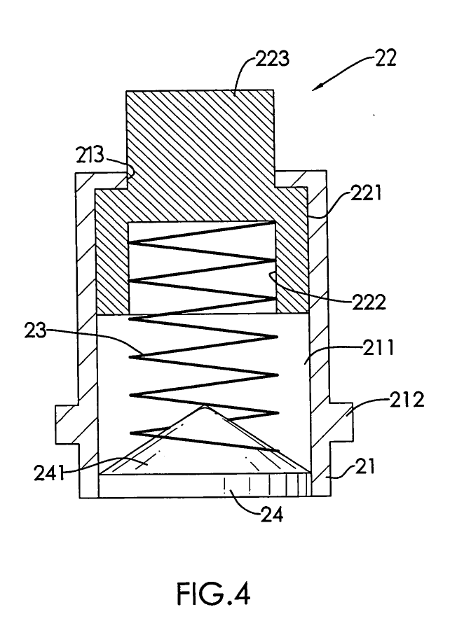

With further reference to FIG. 4, the conductor (22) is mounted movably in the through hole (211) of the housing (21) and has a distal end, a proximal end, a conducting portion (223), a side wall (221) and a recess (222). The proximal end of the conductor (22) is held in the contact end opening (213) of the through hole (211) of the housing (21). The conducting portion (223) is formed on and protrudes out from the proximal end of the conductor (22) and protrudes out from the contact end of the housing (21) to contact with an electrode of a battery. The side wall (221) corresponds to and abuts the inner surface of the housing (21). The recess (222) is formed coaxially in the distal end of the conductor (22).

The spring (23) is mounted in the through hole (211) of the housing (21) and the recess (222) of the conductor (22).

The base (24) is mounted securely in the distal end of the housing (21) and has a mounting surface, an opposing surface and an optional propping portion (241). The mounting surface abuts the spring (23) to press the spring (23) between the base (24) and the conductor (22). The opposing surface is opposite to the mounting surface and is attached to a vehicle to conduct electricity of the battery to the vehicle. The propping portion (241) is conical, is formed on the mounting surface and connects to the spring (23).

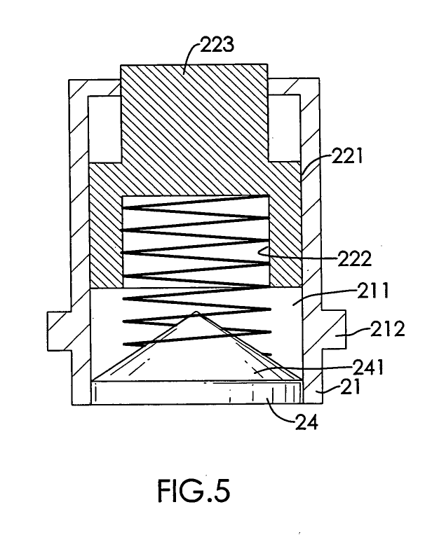

With further reference to FIG. 5, when in use, a battery with an electrode is inserted into the body (10), the electrode of the battery presses against the conducting protrusion (223) of the conductor (22). The conductor (22) is pushed toward the distal end of the housing (21) to compress the spring (23). The spring (23) then pushes the conductor (22) back, the conductor (22) of the conductive component (20) of the battery holder efficiently connecting to the electrode of the battery. Because the conductor (22) has an increased surface to contact with the inner surface of the housing (21) to allow a current produced by a battery to pass through, only few current passes through the spring and possibility of a transient current produced by a battery to cause the spring to melt is decreased. Therefore, the battery holder with the conductive components (20) in accordance with present invention obtains an improved current tolerance.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A conductive component comprising
a housing being conductive and having
a contact end;
a distal end being opposite to the contact end;
an outer surface;
a through hole being formed through the contact end and the distal end; and
an inner surface;
a conductor being mounted movably in the through hole of the housing and having
a distal end;
a proximal end being held in the contact end opening of the through hole of the housing;
a conducting portion being formed on and protruding out from the proximal end of the conductor and protruding out from the contact end of the housing;
a side wall corresponding to and abutting the inner surface of the housing; and
a recess formed coaxially in the distal end of the conductor;
a spring being mounted in the through hole of the housing and the recess of the conductor; and
a base being mounted securely in the distal end of the housing and having
a mounting surface abutting the spring; and
an opposing surface being opposite to the mounting surface.

2. The battery holder as claimed in claim 1, wherein the base further comprises a propping portion being conical and being formed on the mounting surface and connecting to the spring.

3. The battery holder as claimed in claim 1, wherein the through hole in the housing has a contact end opening with a diameter smaller than an inner diameter of the through hole to hold the proximal end of the conductor in the housing.

4. The battery holder as claimed in claim 2, wherein the through hole in the housing has a contact end opening with a diameter smaller than an inner diameter of the through hole to hold the proximal end of the conductor in the housing.
